(19) United States
(12) Patent Application Publication
(10) Pub. No.: US 2018/0056572 A1
(43) Pub. Date: Mar. 1, 2018

(54) APPARATUS AND SYSTEM FOR CONTINUOUS VACUUM FORMING OF EXTRUDED POLYMER SHEETS

(71) Applicant: PLY GEM INDUSTRIES, INC., Cary, NC (US)

(72) Inventors: GARY L. KARR, WESTERVILLE, OH (US); RICHARD R. VEACH, LIBERTY, MO (US); L. REX BAXTER, EXCELSIOR SPRINGS, MO (US); JEFF A. KRATZER, WAYNESBORO, VA (US); BRYAN BEASLEY, KEARNEY, MO (US)

(21) Appl. No.: 15/690,499

(22) Filed: Aug. 30, 2017

Related U.S. Application Data
(60) Provisional application No. 62/381,651, filed on Aug. 31, 2016.

(51) Int. Cl. B29C 51/24; B29C 51/10; B29C 51/02

(52) U.S. Cl. CPC B29C 51/24; B29K 2027/06; B29C 51/02; B29C 51/10

(57) ABSTRACT

An apparatus and method for producing a vacuum formed extruded polymer product employing a plurality of continuously advancing upper and lower mold portions each mounted upon their own track mounted carriage. The adjacent carriages secured to one another by at least one link pin and advanced about the track by at least one drive pin extending outwardly from each carriage for engagement with the flutes of a scroll drive. A lift member is mounted to each lower mold portion for engagement with a closure member wherein as the lift member advances against the closure member on-ramp the lower mold portion elevates until the lift member engages a constant elevation segment wherein the extruded sheet is disposed between the operable vacuum of the upper mold portion and the lower mold portion until the lift member descends the exit ramp of the closure member at the end of the vacuum forming process.

### RELATED APPLICATION

This application claims the benefit of priority of U.S. Application No. 62/381,651 filed on Aug. 31, 2016.

### TECHNICAL FIELD

The present disclosure relates to an apparatus and method for the continuous vacuum forming of polymer based products and particularly as it relates to the fabrication of simulated shake siding panels.

### BACKGROUND

Production of polymer based building products, such as simulated shake siding panels, is a well-established and extensively practiced industry not only in the United States, but worldwide. Generally, polymer based building products are produced in an extrusion process wherein a specially compounded polymer formulation is extruded through one or more dies creating the desired features and texture on the product. One drawback to the extrusion process production line is the inability to vary the features and the texture, or patterns, on the finished product without modifying tooling such as the extrusion dies or embossers. The capability to produce multiple variations of products, such as simulated shake vinyl siding, is critically important when the product is applied to a structure. If there is not some nominal variation in the texture or pattern on the simulated shake siding panels when they are fastened above one another on the side of a building the visual appeal of the siding will be greatly diminished. In order to overcome these visual concerns, a production-line, or method, that is capable of producing at least three simulated shake siding panels is needed. Three separate panels stacked atop one another sufficiently disrupt the visual pattern that is readily apparent when a single pattern or even two patterns, are disposed vertically adjacent to one another.

In order to produce the same product but with even a slightly varied texture or pattern, modified tooling must be employed. These tooling modifications can be expensive in terms of the cost of machining multiple dies as well as time consuming, resulting in downtime and loss of production further reducing profitability of the entire production line. Specifically, a single production line containing extrusion components as well as embossing, vacuum forming, film lamination, calibrating and cut-off tools all of which are configured to produce a single product during any one production run are needed.

### SUMMARY

The technology disclosed herein includes a continuous vacuum forming apparatus as well as a method for the production of a wide range of consumer products including siding panels. The principal advantage of the continuous vacuum forming apparatus and the accompanying method that includes the continuous vacuum forming apparatus is the line speed attainable by the apparatus and method, as much as sixty (60) feet per minute, as well as the ability to vacuum form products that have a varying pattern from one formed product to the next passing through the vacuum forming apparatus.

This ability to produce, for example, simulated shake siding panels with varying textured patterns is critical in the simulated shake industry so that repeating shake patterns are not seen once the panels are installed on a home. The preferred embodiment of the vacuum forming apparatus disclosed herein is capable of continuously producing three distinct simulated shake siding patterns without any tooling changes thereby avoiding the down time associated with tool modifications. In addition, the vacuum forming apparatus produces consistently high quality products readily satisfying stringent quality control requirements.

In addition, building products produced from polyvinyl chloride are particularly appealing to the consumer because they are able to satisfy the rigorous Underwriters Laboratories® UL94 V-0 Flammability Standard. This standard requires, among other criteria, that a specimen may not burn with flaming combustion for more than 10 seconds after the application of a test flame. Due to capability to retard flames, building products, and in particular siding panels fabricated from PVC, are desirable for home construction. Though the embodiment of the apparatus and method that are disclosed herein are directed to the fabrication of simulated shake siding panels, this apparatus and method are capable of producing a wide array of products that may be sold into the stream of commerce.

Various objects, features, aspects and advantages of the inventive subject matter will become more apparent from the following detailed description of preferred embodiments, along with the accompanying drawings in which like numerals represent like components. The contents of this summary section are provided only as a simplified introduction to the disclosure, and are not intended to be used to limit the scope of the appended claims. The contents of this summary section are provided only as a simplified introduction to the disclosure, and are not intended to be used to limit the scope of the appended claims.

### BRIEF DESCRIPTION OF THE DRAWINGS

FIG. 1 illustrates a flow diagram detailing the operations included within the method for forming a simulated shake siding panel;

FIG. 2 illustrates a plan view of an embodiment of a plurality of carriages of the vacuum forming apparatus disposed about the oval track;

FIG. 3 illustrates an embodiment of a carriage and associated upper and lower mold portions;

FIG. 4 illustrates an embodiment of the swivel links that connect the carriages of the vacuum forming apparatus;

FIG. 5 illustrates an embodiment of the flutes of a scroll drive engaging the drive pins of a carriage;

FIG. 6 illustrates an elevation view of an embodiment of the scroll drive in position with all but two carriage mounted molds removed from the view;

FIG. 7 illustrates an elevation view of an embodiment of the closure member that elevates the lower mold portion for the vacuum forming process;

FIG. 8 illustrates the lower mold portions at various elevations as the lift members of the lower mold portions, driven by the scroll drive, advance onto the closure member;

FIG. 9 illustrates an embodiment of an upper mold portion and associated vacuum block advancing toward the vacuum manifold;

FIG. 10A illustrates a plurality of upper mold portions and associated vacuum blocks advancing beneath the vacuum manifold mating block of the vacuum manifold; and

FIG. 10B illustrates an upper mold portion and associated vacuum block advancing beneath the vacuum manifold mating block of the vacuum manifold.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims

Disclosed herein is an apparatus and method for use in fabricating vacuum formed products from a continuously advancing sheet of extruded polymer on a moving production line and that is capable of producing multiple distinct patterns, e.g., textured simulated shake patterns, on adjacent vacuum formed products. The siding panel production method is comprised of a wide array of work tools. A short overview will assist the reader in a better understanding of the operation of the vacuum forming apparatus and the multitude of work tools that cooperate with the vacuum forming apparatus to produce products of varying design on a single production line. The discussion below leads the reader through the startup of the system detailing the process for moving the extruded sheet of polymer through each of the work tools.

An exemplary output of the disclosed apparatus and method is a siding panel; however, this vacuum forming apparatus and method are capable of producing a wide array of home building products. The vinyl siding panel production process, as described immediately below, incorporates the use of the vacuum forming apparatus as one element of the overall vinyl siding production process.

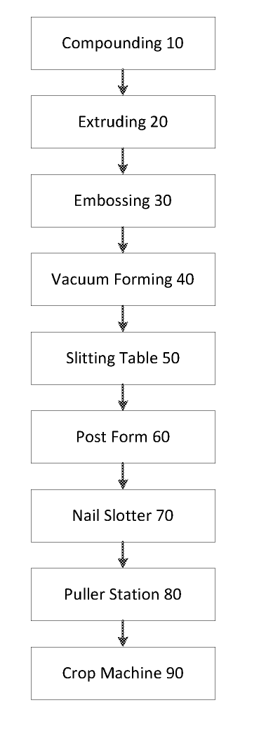

As detailed in FIG. 1, the vinyl siding fabrication process begins with compounding 10 of the polymer material. Compounding is a process of melt plastic blending plastics, with other additives. This process can change the physical, thermal, electrical or aesthetic characteristics of the plastic and the final product is called a compound or a composite. The process of compounding begins with a polymer such as polyvinyl chloride (“PVC”).

The next step in the process of producing the vacuum formed finished product is the extrusion 20 of the compounded PVC. Extrusion is the process used to create objects of a fixed cross sectional profile wherein a material is pushed through a die of the desired cross section. In a preferred embodiment, at least two separate layers of extrudate are formed from the PVC formulation and each is extruded through a separate twin screw extruder into sheet dies to form a single extruded sheet that is preferably in the range of about 0.05 to 0.10 inches thick. The extruded sheets may have varying widths depending upon the specific utilization of the material, such as for seven or nine inch siding panels.

At start-up the extruded sheet is fed through the embossing machine 30 and once continuous operation is achieved the sheet is advanced through the process by a pulling-station that is discussed below. The embossing process adds an embossed texture to the portions of the panel above and below the vacuum formed features that are formed later in the process. Embossing reduces the gloss associated with the extruded sheet so that when the finished product, such as a siding panel, is installed on the wall of the structure there are no undesirable high gloss areas visible to an observer viewing the siding panel.

The extruded and embossed sheet continues to advance through the open molds of the continuous vacuum forming apparatus 40 that will be described in greater detail below. The vacuum forming apparatus is comprised of a plurality of adjacently disposed molds set atop carriages that ride upon an oval track consisting of two spaced-apart rails. Each of the molds comprises an upper mold portion and a lower mold portion and when the vacuum forming apparatus is in operation the extruded sheet which is simultaneously advancing with the plurality of molds is positioned between the upper and lower mold portions and a vacuum is applied to the sheet through a port within the upper mold portion. The suction of the vacuum pulls the polymer sheet into a specially fabricated insert that is mounted to the upper mold portion. When drawn tightly against the fabricated insert by the suction of the vacuum, the topography of the upper mold portion is imprinted upon the polymer sheet. For example, in the case of vacuum forming shake siding panels, the upper mold portion impresses a wood grain pattern onto the polymer siding panel.

The vacuum to the upper mold portion is supplied through a stationary manifold. Each upper mold portion includes an upper mold portion vacuum block that slides past the stationary vacuum manifold at the speed of the production line. Even while advancing at the pace of the production line, the vacuum circuit passing through the upper mold portion remains intact thereby allowing the vacuum to pull the extruded sheet into contact with the upper mold portion insert that forms the desired impression upon the extruded sheet. Once the vacuum forming process is complete the lower mold portion drops away from the upper mold portion thereby freeing the advancing, and now vacuum formed extruded sheet, to advance to the next forming operation.

The extruded, and now vacuum formed sheet, advances to the slitting table 50. The slitting table heats the edges of the extruded sheet thereby allowing the first and second longitudinally extending edges and the material adjacent the edges to become sufficiently soft and pliable and passes the heated first and second edges over a knife edge that trims excess pliable material from the extruded sheet cutting the sheet to the preferred width.

After being trimmed to the desired sheet width at the slitting table 50 the extruded 20, embossed 30, vacuum formed 40 and slit sheet 50 passes through a post forming operation 60 which forms and shapes the top and bottom locks. Vinyl siding panels utilize formed locks on the upper (first) and lower (second) edges of the panels to lock vertically adjacent panels together when applied to a structure. Next, the extruded sheet advances to the nail slotter 70 which punches the nail slots into the top hem of the panel. The next-to-last station into which the extruded sheet advances is the puller station 80. The puller station engages with the extruded sheet of polymer and pulls the advancing sheet through the entire collection of stations detailed above. The final station is the crop machine 90 that cuts the formed PVC siding panels to the desired length.

As will be discussed in greater detail below, the puller station 80 in conjunction with a programmable logic controller, matches the speed of the carriages of the continuous vacuum forming apparatus 40 and the rate at which the two twin screw extruders 20 are capable of dispensing the extruded sheet of material to create a continuously moving uniform product that passes through the vacuum forming apparatus.

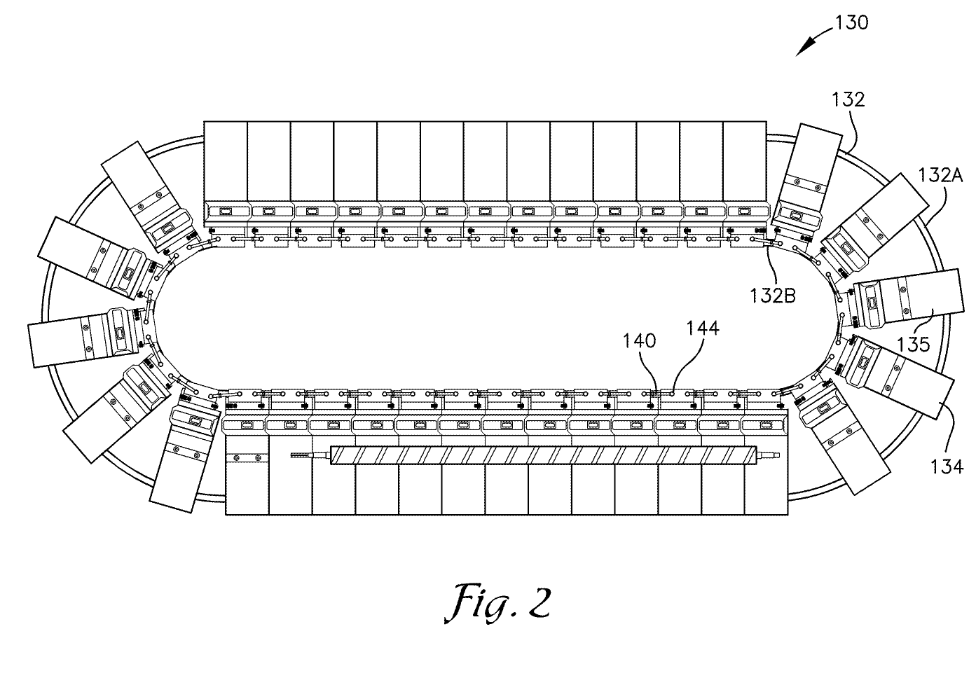

As seen in FIG. 2, the vacuum forming apparatus 130 is disposed on an oval shaped track 132. The oval track is preferably comprised of an outer rail 132A and an inner rail 132B which are spaced apart sufficiently to provide stability to the vacuum forming elements resting on the rails 132A and 132B. The rails are preferably comprised of a rigid and durable metal, such as steel, and are preferably circular in cross section. Positioned on the track 132 are a plurality of movable adjacently disposed two part molds 134 each mold pair riding atop a separate carriage 135.

The precise number of carriages 135 and associated two part molds 134 deployed on the track 132 is dependent upon the number of desired variations of the products being produced, such as simulated shake siding panels. In a typical siding application, for example, a total of 36 carriages and two-part molds 134 may be deployed on the track 132 at any one time with a total of twelve two part molds continuously engaged in the vacuum forming of a panel.

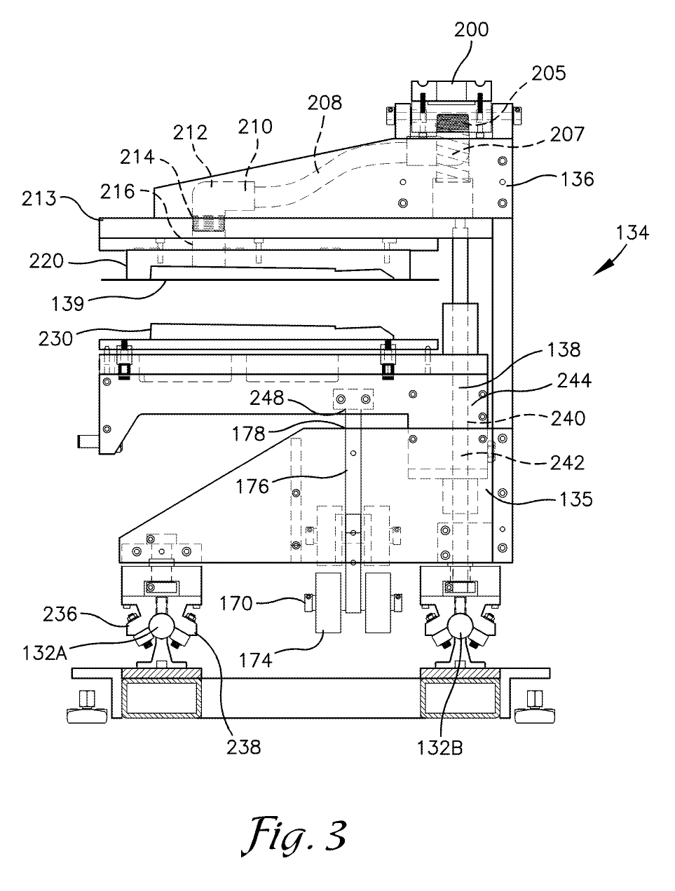

As seen in FIG. 3 and as discussed above, each two part mold 134 is further comprised of an upper mold portion 136 and a lower mold portion 138. The lower mold portion 138 is configured to descend and separate from the upper mold portion 136 at the end of the vacuum forming process and to remain in the open position until returning to the start of the vacuum forming process where the continuously advancing extruded sheet 139 of PVC enters into the gap between the upper and lower mold portions 136, 138. When a two part mold 134 completes the vacuum forming process it traverses atop the carriage 135 around the oval track until returning to the start of the vacuum forming process once again. The two-part molds 134 and associated carriage 135 are in a process of continuous recirculation about the oval track 132.

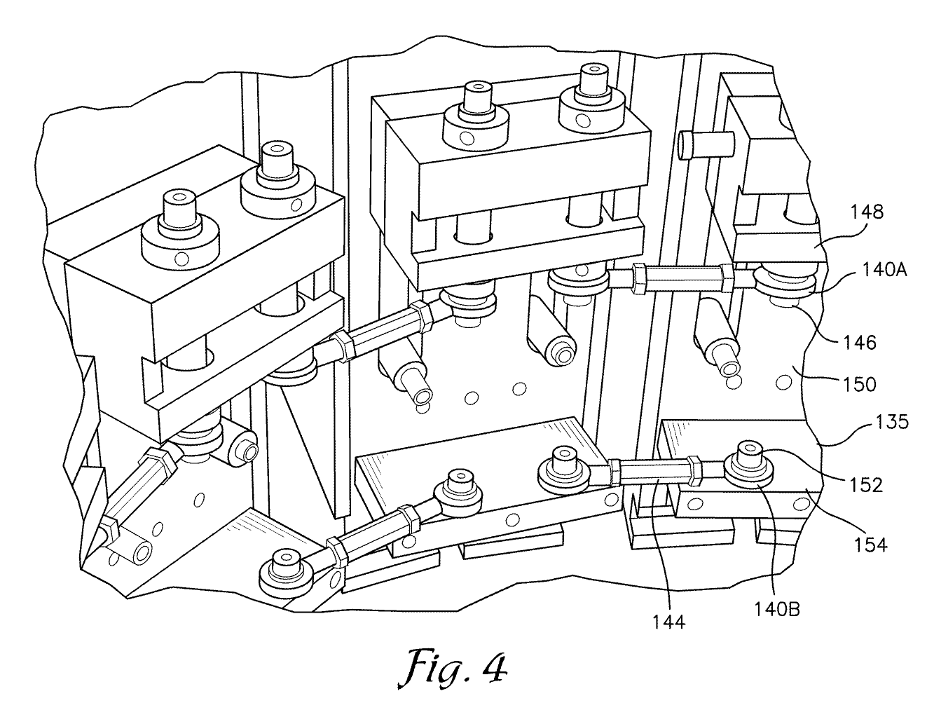

As shown in FIG. 4, connecting each mold carriage 135 to the adjacent mold carriage is at least one, and preferably two, swivel links 140A, 140B. The swivel links 140A, 140B ensure that the mold carriages 135 are separated by a precise and unchanging distance in order to vacuum form the extruded sheet 139 into a high quality finished product without manufacturing defects. The swivel, or rotational aspect of the links 140A, 140B is critical due to facilitating motion of the carriages 135 as they traverse around the track 132. The carriages 135 translate along the two linear portions of the track and then must traverse the curved portions of the track all the while maintaining a close and unyielding association with adjacent carriages 135 on each side.

The tightly controlled spacing of the adjacent carriages 135 is critical for maintaining the high quality appearance of the vacuum formed products. The swivel links 140A, 140 B accommodate the rotation of the carriages as each carriage rounds the curved portions of the oval track 132. The swivel links are adjustable in length by rotating turnbuckles 144 that are mounted between the swivel links 140A and 140B. The upper swivel links 140A are rotatably secured to posts 146 extending downwardly from a bracket member 148 extending outwardly from the backside 150 of the carriages 135. The lower swivel links 140B are rotatably secured to posts 152 extending upwardly from a lower shelf 154 of the backside 150 of the carriage 135.

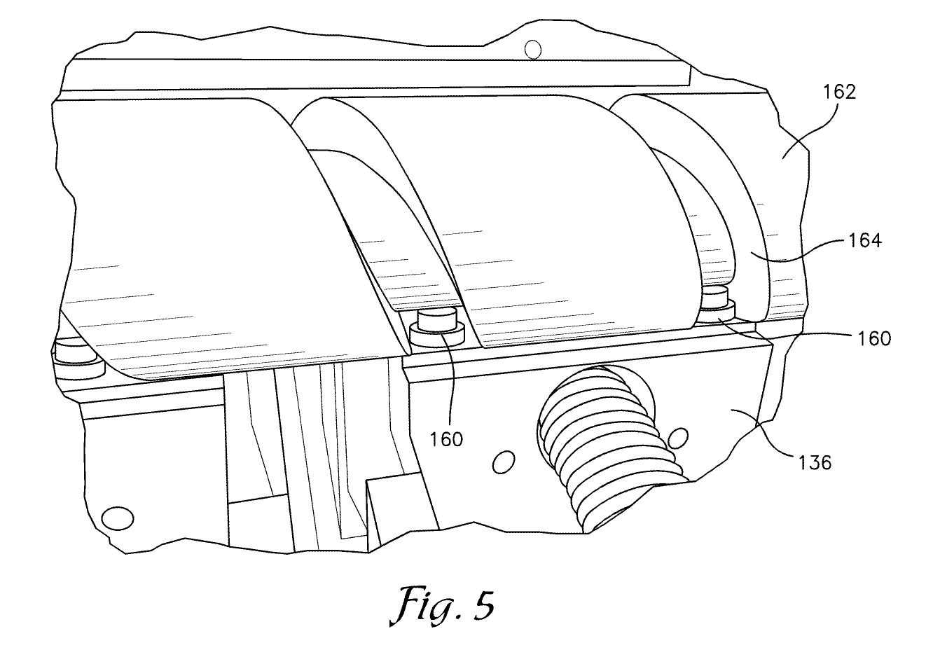

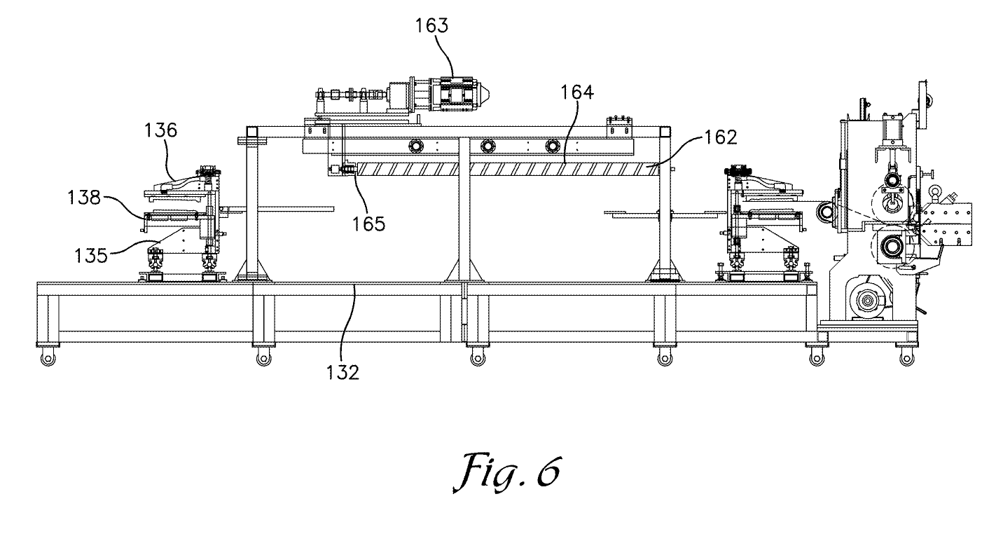

FIG. 5 reveals that extending outwardly and rearwardly from each of the upper molds 136 is at least one, and preferably two, drive pins 160. A scroll drive 162 with flutes 164 is utilized to drive the multitude of carriages 135 with upper and lower mold portions 136, 138 around the track 132. FIG. 6 reveals that the scroll drive 162 is driven by a drive motor 163 that is in operable communication with other systems and is controlled by either a programmable logic controller or a programmable computer in order to orchestrate movements of the various components, i.e., extruder, scroll drive motor, etc. Once a flute 164 of the scroll drive 162 picks up, or captures, the first drive pin 160, that drive pin is propelled along the length of the scroll drive by the rotation of the flute 164.

When the drive pins 160 depart the flute 164 at the opposite end 165 of the scroll drive 162, the carriage 135 and the associated upper and lower molds 136, 138 continue to advance around the track 132 due the interconnectedness of the plurality of carriages by the swivel links 140A, 140B. Even those carriages 135 that do not have a drive pin 160 engaged within the flute 164 of the scroll drive 162 continue to circulate around the track 132 because all of the carriages are interconnected through the swivel links 140. Some subset of all of the carriages, for example, in the preferred embodiment a total of 12 carriages out of 36, utilize drive pins 160 engaged by the flute 164 of the scroll drive 162 at any one time.

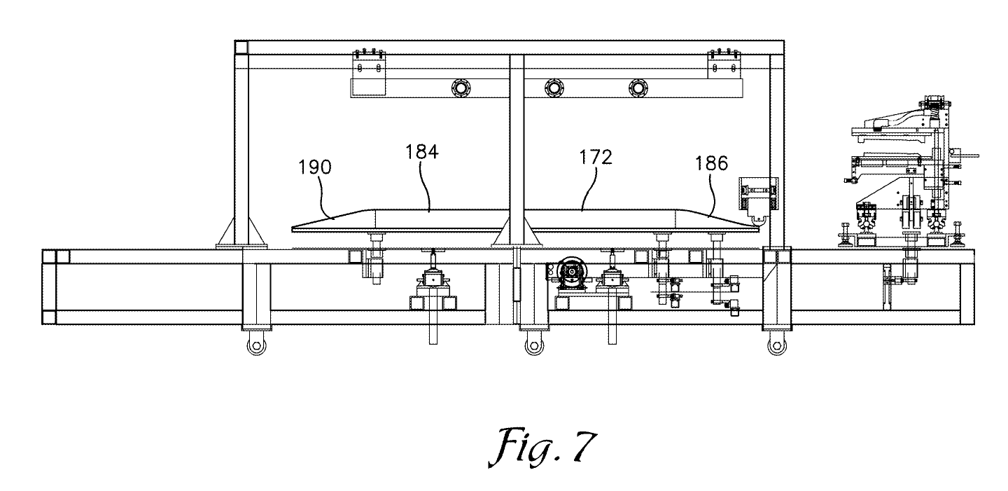

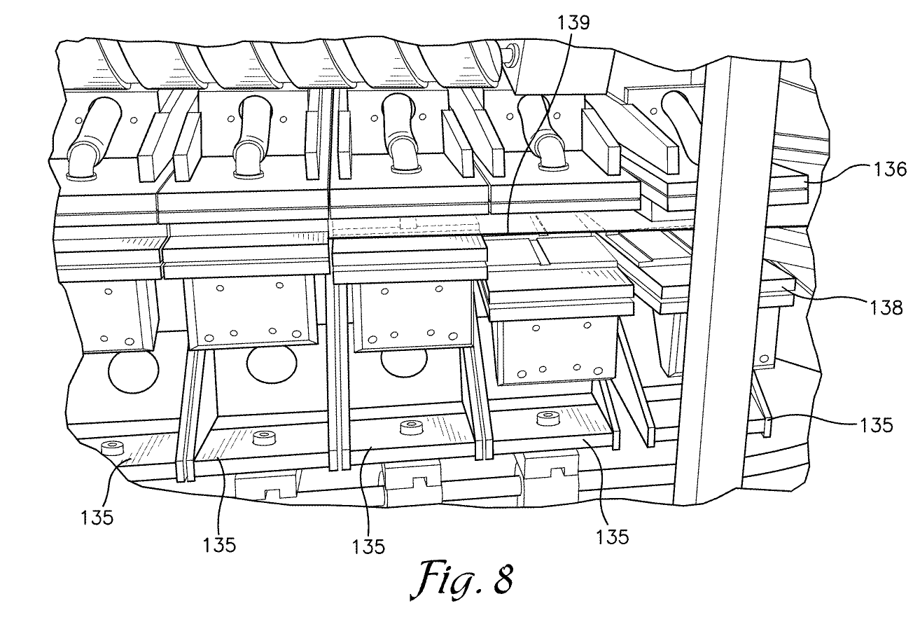

Returning to FIG. 3, a lift member 170 is secured to each carriage 135 for operable engagement with a closure member 172 shown in FIG. 7. The lift member 170 is comprised of a wheeled member 174 attached to a lift arm 176 wherein the opposite end 178 of the lift arm 176 is disposed beneath the lower mold member 138 and is configured to lift the lower mold member 138 in order to capture the extruded sheet 139 between the upper and lower mold members and apply a vacuum thereto. As seen in FIG. 7, the closure member 172 is an elevated platform 184 across which the lift member 170 rides. The elevated platform 184 has an on-ramp 186 and an off-ramp 190 for the lift member to access and exit the elevated platform 184. As the lift member 170 advances to the closure member 172 the lift member first enters onto the closure member on-ramp 174. Upon advancing to the on-ramp 186 the lower mold portion 138 begins to ascend until the lift member 170 transitions onto the elevated platform 184. FIG. 8 details multiple carriages 135 and associated upper and lower mold portions 136, 138 in various stages of lift with the fourth from left lower mold portion 138 about to begin the ascent upon the on-ramp 186 and the upper and lower molds separated and thereby allowing access of the extruded sheet 139 (not shown). The two left-most lower mold portions 138, as shown in FIG. 8, have fully closed the separation between the upper mold portion 136.

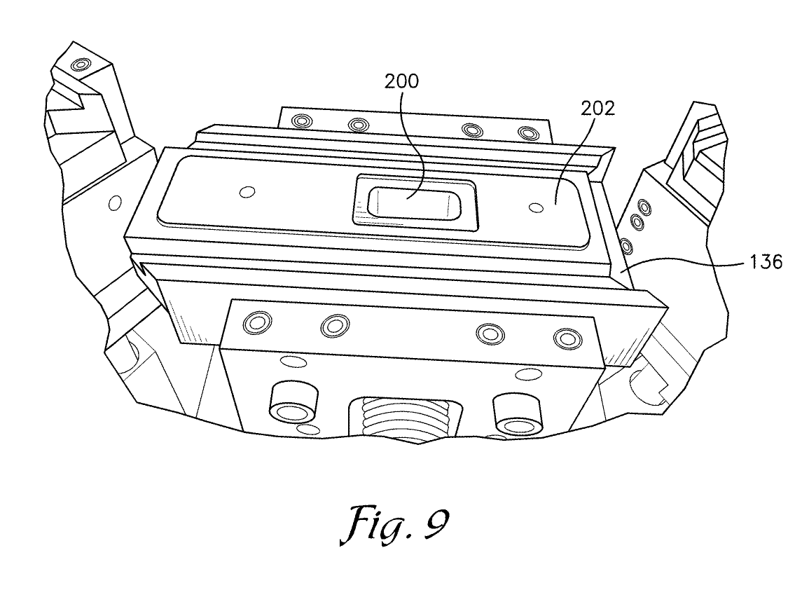

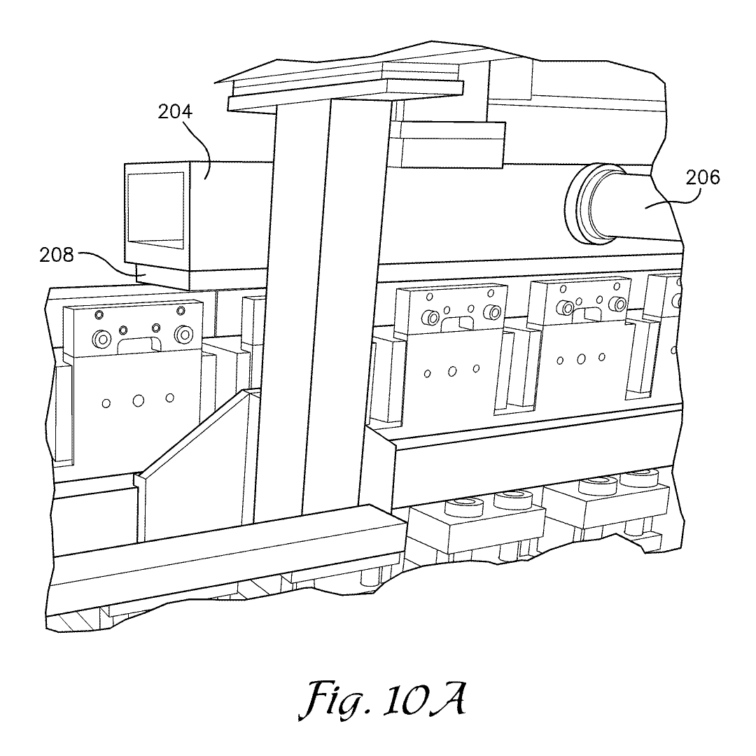

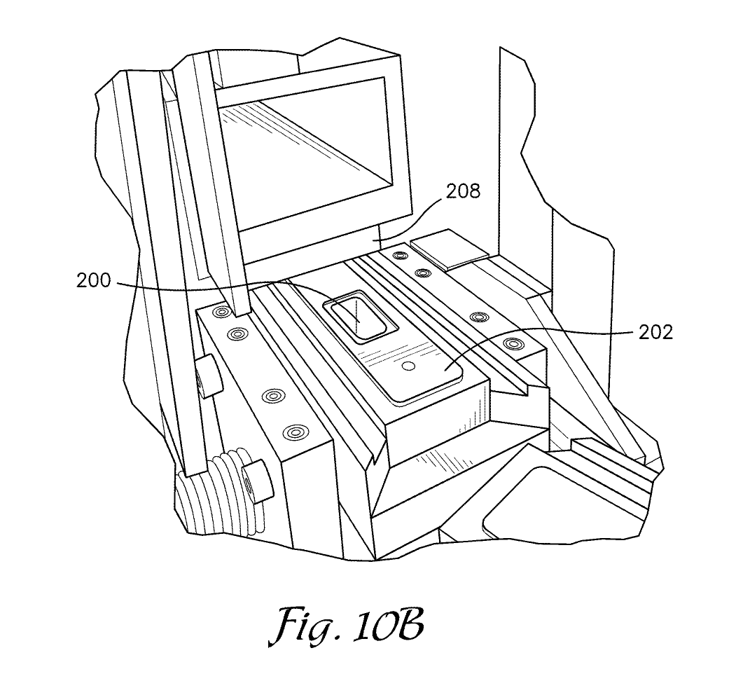

Once the lift member 170 arrives at the elevated platform 184 the extruded sheet 139 of PVC is tightly captured between the upper mold portions 136 and the lower mold portion 138. As shown in FIG. 9, for those upper and lower mold portions 136, 138 in contact with the extruded sheet 139 a vacuum (reduced air pressure) is supplied through an opening 200 in a vacuum block 202 that is secured to the top of each of the upper mold portions 136. The vacuum blocks 202 are preferably fabricated from an engineered plastic material that is both durable and abrasion resistant. Positioned above the vacuum blocks 202, in the area of the vacuum forming operation, as shown in FIGS. 10A and 10B, is a longitudinally extending fixed position vacuum manifold 204 connected to a primary vacuum line 206. The primary vacuum line 206 provides sufficient vacuum to the manifold 204 to supply all of the closed molds 134 that are passing beneath the manifold at any one time.

Mounted to the bottom of the vacuum manifold 204 is a vacuum mating block 208 that creates a seal between the vacuum manifold block 204 and the vacuum block 202 associated with each of the mold sets. In an embodiment of the apparatus that vacuum forms the siding panels, the vacuum manifold 204 and the vacuum mating block 208 extend the length of approximately twelve sets of molds 134 or the number of molds in this embodiment required to produce a single panel of vinyl siding. The vacuum mating block 208 is also preferably fabricated from a tough, yet durable, engineered plastic material in order to maximize wear resistance and reduce the cost of replacement once wear begins to degrade the integrity of the seal required to maintain a sufficient vacuum.

The force of the vacuum pulls the extruded sheet 139 into the upper mold portion insert 214 causing the malleable extruded sheet 139 to take on the topography of the insert 214 mounted to the upper mold portion 136. The extruded sheet 139 vacuum molding processes continues until the lift member 170 descends the off-ramp 190 of the closure member 172 causing the lower mold portion 138 to separate from the upper mold portion 136. As the lower mold portion 138 descends the extruded sheet 139 releases from the upper insert 214 freeing the sheet 139 to advance out of the vacuum forming portion of the process.

Returning to FIG. 3, the lower area 205 of the opening 200 in the vacuum block 202 is in communication with a first elbow 206 that bends 90 degrees and leads to a connection 207 with a flexible hose 208. The flexible hose 208 traverses over the upper mold portion 136 and connects to an end 210 of a second elbow 212 mounted near the front 213 of the upper mold portion 136. The second elbow 212 turns downward at the second end 214 of the elbow and is mounted atop an opening 216 in the upper mold portion 136. The opening 216 in the upper mold portion 136 leads into an opening 218 in the upper insert 220 thereby completing the vacuum path to the extruded sheet 139. The vacuum supplied to the upper insert 220 may be applied to the extruded sheet 139 only at the opening 218 in the upper insert 220 or alternatively the vacuum may be distributed across the entire upper insert 214 by placement of small holes (not shown) distributed across the upper insert 220. The purpose of the supplied vacuum is to suction the extruded sheet 139 up against the surface 222 of the upper insert 220 in order to transfer the topography of the upper insert 220 to the extruded sheet 139.

As also seen in FIG. 3, the lower mold portion 138 employs a lower insert 230 that is secured to the lower mold portion 138; however, the lower mold portion does not rely upon a ducted vacuum as does the upper mold portion 136. The lower mold portion 138 rises upon entering the carriage entering the on-ramp 186 but the carriage 135 upon which the lower mold portion 138 is mounted remains secured to the rails 132A, 132B as the carriage is restrained in position by canted restraints 236, 238. The lower mold portion 138 slides up and down upon a carriage slide assembly 240 comprising a tube 242 and collar 244 centrally disposed within the two part mold 134. The collar 244 is rigidly connected to the lower mold portion 138 and as the wheeled member 176 of the lift member 170 advances onto the on-ramp 186 an upward force is applied by the lift member 170 to a bottom surface 248 of the lower mold portion 138 causing the lower mold portion and the associated lower insert 230 to close the gap between itself and the upper insert 220 and the upper mold portion 136.

The lower mold portion 138 remains in an elevated position while the lift member 170 remains on the elevated platform 184. Once the lower mold portion 136 is elevated to the uppermost position the advancing extruded sheet 139 is captured between the upper insert 220 and the lower insert 230 and vacuum is being applied to the sheet 139 through the fixed position manifold 204 to the upper vacuum block 202 and ultimately to the upper insert 220. As the lift member 170 advances down the off-ramp 190 the lower mold portion 138 descends opening the mold 134. As the mold opens and the carriage 135 advances on the track 132, the opening 200 in the vacuum block 202 passes from beneath the vacuum mating block 208 and loses the connection to the vacuum supply manifold.

When the vacuum formed sheet 139 exits the vacuum forming apparatus 130, the formed sheet advances to undergo the post forming 60 operations. First among those operations is a slitting table 50 which removes excess material from both edges of the advancing sheet 139. After the edges of the sheet 139 are slit, the sheet advances to additional post forming operations 60 for forming of the locking features found on vinyl siding panels.

Zone 1 begins the post forming process that includes calibration of the locking components on the first longitudinally extending edge of the vinyl siding panel. The first edge of the panel is softened with heat and then bent, with calibration hardware that is well known by those skilled in the art, approximately 90 degrees before being cooled causing the vinyl siding to harden and set in position. The vinyl siding panel then enters zone 2 where the first edge of the panel is bent with calibration hardware another 110 degrees to complete formation of the butt lock return leg.

The second longitudinally extending edge of the panel undergoes forming operations simultaneously with the first edge. In Zone 3 the second edge is exposed to an infrared heater that softens the polymer prior to forming, in a vacuum calibrator, the entry flange for the top lock. Once the entry flange is formed the edge is cooled to facilitate setting of the polymer. Once set, the panel proceeds to zone 4. In zone 4 an area proximate the edge is heated prior to entering another calibration station which bends the nail hem roughly 180 degrees to complete the nail hem structure.

As shown in FIG. 1, once the post forming operations 60 are completed the panel proceeds to the nail slotter 70. The production process may employ a puller station 80 that is used to maintain a constant tension on the polymer sheet 139 as it advances through the various processes. Once nail slots are formed the final operation is the crop machine 90 which cuts the fully formed sheet to the specified length. The formed and cropped panel is then boxed for shipment to the designated customer.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the present invention should be considered in terms of the following claims and is understood not to be limited to the details of structure and operation shown and described in the specification and drawings. Moreover, the order of the components detailed in the system may be modified without limiting the scope of the disclosure.

We claim:

1. An apparatus for continuously vacuum forming an extruded polymer sheet, the apparatus comprising:
an oval track;
a closure member with an on-ramp, a constant elevation segment and an exit ramp;
a plurality of adjacently disposed carriages, the carriages disposed atop the oval track, each carriage further comprising:
a) an upper mold portion and a lower mold portion;
b) at least one link pin securing each of the carriages to an adjacent carriage on each side;
c) at least one drive pin extending outwardly from each upper mold portion;
d) a lift member disposed beneath each lower mold portion for operable engagement with the closure member wherein as the lift member advances against the closure member the on-ramp the lift member raises the lower mold portion, the ascent of the lower mold portion terminating as the lift member transitions to the constant elevation segment and the extruded polymer sheet is captured between the upper mold portion and the lower mold portion until the lift member descends the exit ramp of the closure member at the end of the vacuum forming process and the lower mold portion descends away from the upper mold portion;
e) a vacuum port disposed within the upper mold portion configured for operable engagement with a vacuum manifold while the lift member traverses the constant elevation segment; and
a scroll drive configured for operable engagement with the at least one drive pin of a subset of the plurality of adjacently disposed carriages.

2. The apparatus of claim 1, wherein the vacuum port is disposed within an upper area of the upper mold portion for operable engagement with a vacuum manifold as each continuously moving upper mold portion element advances through the vacuum forming process.

3. The apparatus of claim 1, wherein the upper mold portion further comprises a removable insert for imprinting a pattern upon the advancing extruded polymer sheet.

4. The apparatus of claim 3, wherein the polymer sheet is pulled into the removable insert within the upper mold by the vacuum delivered through the vacuum manifold.

5. The apparatus of claim 4, wherein the lower mold portion further comprises a removable insert.

6. The apparatus of claim 1, wherein the number of adjacently disposed carriages riding upon the oval track is in the range of between 30 and 50 carriages.

7. The apparatus of claim 1, wherein the at least one link pin securing each of the adjacent carriages to one another is comprised of a swivel link that is adjustable in length.

8. The apparatus of claim 1, wherein the at least one drive pin is two drive pins.

9. The apparatus of claim 1, wherein the lift member secured to each lower mold portion for operable engagement with the closure member further comprises a wheeled member and a lift arm.

10. The apparatus of claim 1, wherein the oval track is further comprised of at least two rails.

11. The apparatus of claim 1, wherein the scroll drive is driven by an electric motor.

12. The apparatus of claim 1, wherein the subset of the plurality of adjacently disposed carriages engaged by the scroll drive at any one time is in the range of from 8 to 14 carriages.

13. A method for continuously vacuum forming an advancing polymer sheet, the method comprising:
installing an oval track;
fabricating a plurality of individual upper and complimentary lower mold portions configured for mounting atop a carriage, the upper and lower mold portions configured for engagement with and forming the topography of the advancing polymer sheet;
installing a closure member with an on-ramp, a constant elevation segment and an off-ramp proximate the oval track;
positioning a lift member for operable engagement with the lower mold portion and the carriage, the lift member configured for rolling engagement with the closure member;
advancing a plurality of the carriage mounted upper and lower mold portions continuously around the oval track;
rotatably linking to one another the plurality of circulating carriages;
advancing the lift member up the on-ramp of the closure member therein causing the lower mold portion to advance toward the upper mold portion;
continuing passage of the polymer sheet through a subset of the continuously circulating upper mold portions and complimentary lower mold portions;
routing a vacuum into the subset of the plurality of upper molds as the same subset of the lift members advance across the constant elevation segment of the closure member;
drawing upwardly with the vacuum the advancing sheet of polymer into the upper mold portion to imprint a topography onto the polymer sheet;
maintaining vacuum upon the advancing polymer sheet through the upper mold portion until the lift member begins descent upon the off-ramp of the closure member;
terminating the vacuum through the upper mold portion; and
releasing the advancing polymer sheet from the upper mold portion.

14. The method of claim 13, wherein a scroll drive is used to advance around the oval track the plurality of carriages mounted to the upper and lower mold portions.

15. The method of claim 14, wherein at least one pin is mounted to each upper mold and the pin engages with the scroll drive to advance the carriage mounted upper and lower mold portions.

16. The method of claim 15, wherein upper and lower inserts containing the desired topographical features for transfer to the advancing polymer sheet are mounted respectively to the upper and lower mold portions.

17. The method of claim 16, wherein the step of routing the vacuum into a subset of the continuously circulating upper mold portions from a vacuum manifold further comprises a vacuum block disposed atop the upper mold portion, the vacuum block containing a vacuum port.

18. The method of claim 17, wherein the vacuum port is in operable communication with the upper insert.

19. An apparatus for forming a continuously advancing sheet of extruded polymer, the apparatus comprising:
an oval shaped track;
a closure member with an on-ramp, a constant elevation segment and an exit ramp;
a plurality of continuously moving adjacently disposed carriages, the carriages movably positioned atop the oval track, each carriage further comprising:
a) an upper mold portion and a lower mold portion;
b) at least one link pin securing each of the adjacent carriages to one another;
c) at least one drive pin extending outwardly from each upper mold portion;
d) a lift member for operable engagement with the closure member wherein as the lift member advances against the closure member on-ramp the lower mold portion elevates until the lift member engages the constant elevation segment and the extruded polymer sheet is disposed between the upper mold portion and the lower mold portion until the lift member descends the exit ramp of the closure member terminating the vacuum forming process; and
e) a vacuum port disposed within the upper mold portion for operable engagement with a vacuum manifold while the lift member is engaged with the constant elevation segment; and
a scroll drive configured to operably engage the at least one drive pin of a subset of the plurality of adjacently disposed carriages.

20. The apparatus of claim 19, wherein the oval track is further comprised of at least two rails.

21. The apparatus of claim 19, wherein the upper mold portion further comprises a removable insert with a pattern thereon.

22. The apparatus of claim 21, wherein the lower mold portion further comprises a removable insert with a pattern thereon.

23. The apparatus of claim 22, wherein the lower mold portion closes against the advancing polymer sheet and the upper mold portion imprinting the pattern of the inserts onto opposite sides of the polymer sheet.

24. The apparatus of claim 19, wherein the at least one link pin securing each of the adjacent carriages to one another is comprised of two swivel links and an adjustable turnbuckle.

25. The apparatus of claim 19, wherein the lift member disposed beneath each lower mold portion further comprises a lift arm and a wheeled member.

26. The apparatus of claim 19, wherein the vacuum port is disposed within the top of a vacuum block atop the upper mold portion for operable engagement with a vacuum manifold.
